(19) United States
(12) Patent Application Publication
(10) Pub. No.: US 2026/0059231 A1
(43) Pub. Date: Feb. 26, 2026

(54) BASS LOUDSPEAKER SYSTEM

(71) Applicant: PSS BELGIUM NV, Dendermonde (BE)

(72) Inventor: Fabian VUINE, Dendermonde (BE)

(21) Appl. No.: 19/104,876

(22) PCT Filed: Aug. 22, 2023
(86) PCT No.: PCT/EP2023/073013

§ 371 Date: Feb. 19, 2025

(30) Foreign Application Priority Data
Sep. 5, 2022 (GB) 2212935.7

(51) Int. Cl. H04R 1/28; H04R 1/22; H04R 9/02; H04R 9/06

(52) U.S. Cl. CPC H04R 1/288; H04R 1/227; H04R 1/2896; H04R 9/025; H04R 9/063; H04R 2207/021; H04R 2400/11; H04R 2499/13

(57) ABSTRACT

A bass loudspeaker system including: a housing; a first and second diaphragm; a first and second drive unit, each drive unit including a stationary part and a translatable part. The translatable part of the first drive unit is attached to the first diaphragm to form a first moving assembly suspended by a first surround and a first damper, and the translatable part of the second drive unit is attached to the second diaphragm to form a second moving assembly suspended by a second surround and a second damper. The system energises the drive units to cause the first and second moving assemblies to move along a movement axis in opposite directions to produce sound. The first surround includes an outside tab, an inside tab, and a surround body between the outside and inside tabs. The second surround includes an outside tab, an inside tab, and a surround body between the outside tab and the inside tab. The first damper-includes an outside tab attached to the housing, an inside tab attached to the first moving assembly and a damper body between the outside tab and the inside tab. The second damper includes an outside tab attached to the housing, an inside tab attached to the second moving assembly and a damper body between the outside tab and the inside tab. The width of the damper body of the first damper as measured in a direction of measurement perpendicular to the movement axis is greater than the width of the surround body of the first surround in said direction of measurement. The width of the damper body of the second damper as measured in said direction of measurement is greater than the width of the surround body of the second surround in said direction of measurement.

This application claims priority to GB2212935.7, filed 5 Sep. 2022.

### FIELD OF THE INVENTION

The present invention relates to a bass loudspeaker system.

### BACKGROUND

In some traditional bass loudspeakers, a moving assembly is suspended in a frame by mechanical suspension means including a surround and a damper. In operation, the moving assembly is displaced along a movement axis to produce sound which causes the surround and the damper to become deformed.

Careful design of the surround and particularly the damper may be required to avoid sound distortion because of the deformation of the surround and the damper. It is possible without much effort to design a traditional surround to provide a suitable linear response over the working range of the bass loudspeaker, where the mechanical dimensions of the surround may be correlated to maximum displacement of the moving assembly. By contrast, design of a suitable damper may require dedicated engineering effort to achieve the desired linearity. Some traditional dampers have undulating bodies made from canvas-woven cloth which is dipped in a thermoset resin and baked to final shape. The parameters relevant to the stiffness of the damper and its response to deformation may include the number of waves of the undulating body, the height-to-pitch ratio, the particulars of the cloth and weaving type, the type of resin and resin density. Each such parameter may all have a substantial influence on the stiffness of the damper for a given displacement. Even where these parameters have been chosen optimally, the achievable maximal displacement is dictated by the outside diameter of the damper which, the present inventor observes, is limited by the frame of the bass loudspeaker. Beyond a certain displacement, the stiffness curve of the damper may become very progressive, leading to a non-linear input-output relationship whereby an increase in voltage does not linearly translate into a corresponding increase in displacement.

The present invention has been devised in light of the above considerations.

### SUMMARY OF THE INVENTION

Known loudspeaker assemblies traditionally include an enclosure in which a loudspeaker is mounted. The loudspeaker traditionally includes a loudspeaker frame of (frusto-) conical shape without undercuts, owing to traditional manufacturing processes employed, e.g. deep drawing and stamping or injection moulding of polymers, so that the loudspeaker frame can be effectively formed by one or several tools acting strictly axial with respect to a final main radiation axis of the loudspeaker. The resulting conical shape of the loudspeaker frame means that an outside diameter of a surround (mounted at a wide end of the conical shape) is necessarily larger than an outside diameter of a damper (mounted towards a narrow end of the conical shape).

Herein is described a bass loudspeaker system that may be viewed as departing from these conventional manufacturing processes and breaking with the accepted design limitations. More particularly, the inventor recognised that the outlined conventional loudspeaker configuration of a moving assembly within a conical frame within in an enclosure (or ‘box’) may be replaced by an alternative configuration wherein the frame and the enclosure need not be separate structures, whereby accepted design limitations and resulting performance limitations may be addressed.

Particularly where multiple moving assemblies are provided together, e.g. in a force-cancelled configuration, these may be suspended within the same structure serving as both frame and enclosure. By contrast, traditional loudspeaker assemblies would rely on an individual frame per loudspeaker and an overall enclosure in which the individual loudspeakers are mounted.

As a result of the alternative configuration described herein, whereby the frame and the enclosure need not be separate structures, certain structural limitations affecting particularly damper design may be addressed since damper placement may not be restricted by available space in a conical loudspeaker frame, as would be the case in a traditional loudspeaker.

According to a first aspect of the invention, there is provided a bass loudspeaker system including a housing; a first diaphragm and a second diaphragm; a first drive unit and a second drive unit, each drive unit including a stationary part attached to the housing and a translatable part; wherein the translatable part of the first drive unit is attached to the first diaphragm to form a first moving assembly suspended from the housing by a first surround and a first damper, and the translatable part of the second drive unit is attached to the second diaphragm to form a second moving assembly suspended from the housing by a second surround and a second damper; wherein the loudspeaker is operable to energise the first drive unit and the second drive unit to cause the first moving assembly and the second moving assembly to move along a movement axis in opposite directions to produce sound; wherein the first surround includes an outside tab attached to the housing, an inside tab attached to the first diaphragm, and a surround body between the outside tab and the inside tab; wherein the second surround includes an outside tab attached to the housing, an inside tab attached to the second diaphragm, and a surround body between the outside tab and the inside tab; wherein the first damper includes an outside tab attached to the housing, an inside tab attached to the first moving assembly and a damper body between the outside tab and the inside tab; wherein the second damper includes an outside tab attached to the housing, an inside tab attached to the second moving assembly and a damper body between the outside tab and the inside tab; wherein the width of the damper body of the first damper as measured in a direction of measurement perpendicular to the movement axis is greater than the width of the surround body of the first surround in said direction of measurement; and wherein the width of the damper body of the second damper as measured in said direction of measurement is greater than the width of the surround body of the second surround in said direction of measurement.

As outlined above in the Background section, in a traditional bass loudspeaker frame it may not be feasible to have a damper which is wider than the surround due to accepted manufacturing conventions and constraints attached thereto. By contrast, the bass loudspeaker system according to the first aspect does not adhere to these conventions and instead provides a housing which accommodates a first diaphragm and a first drive unit as well as a second diaphragm and a second drive unit without requiring a traditional frame for either. This enables accommodating a wider damper (body) around the moving assembly, and which exceeds that of the surround. As a result, a linear response to displacement may be achievable for a larger displacement than would be possible for a traditional bass loudspeaker, since the width of a traditional bass loudspeaker's suspension would be limited by the conical shape of each individual loudspeaker frame.

It is noted that the term “width” may be used to designate the maximal extent of a structure (e.g. damper body/surround body) in a specified direction, i.e. the longest measurable extent of a structure in a specified direction, and so may be regarded as following a natural understanding of the term, as opposed to an arbitrary measure in said direction.

In some examples, the width of the damper body of the first damper as measured in any direction of measurement perpendicular to the movement axis may be greater than the width of the surround body of the first surround in said direction of measurement (i.e. the width of the damper body of the first damper may be greater than the width of the surround body of the first surround in all possible directions of measurement perpendicular to the movement axis). However, this is not a requirement of the invention since examples could be envisaged where the width of the damper body of the first damper is only greater than the width of the surround body of the first surround in one or more directions of measurement (see e.g. the oval/racetrack variants discussed in the specific description, below).

Where optional features are set out below with respect to the first diaphragm and/or the first drive unit and/or the first surround and/or the first damper, it is understood that such optional features are applicable also, or alternatively, to the second diaphragm and/or the second drive unit and/or the second surround and/or the second damper.

The bass loudspeaker system as described above may be configured to produce sound with frequencies in a bass frequency range. The bass frequency range may include 60-80 Hz, where “Hz” represents the physical unit “Hertz”. More preferably, the bass frequency range may include 40-100 Hz. By way of example, the bass frequency range may be 20 Hz-100 Hz. The bass loudspeaker system may be provided as a subwoofer system, configured only to produce sound in a bass frequency range, e.g. 250 Hz or less. The housing may define an internal volume in a range of 0.25 litres to 5 litres in which the loudspeaker is mounted. In some examples, the internal volume may be up to 1.5 litres. Such volumes are typical for bass loudspeaker systems.

The term “tab” may be taken as referring to a structural feature of the respective surround or damper by means of which the respective surround or damper is attached to another structure. Traditionally this structural feature may have the shape of a tab, e.g. a flat portion, but other shapes are also possible and may depend on the means by which the tab is attached to the other structure. In some examples, the tab may correspond to an edge of the surround or damper or a line along the surround or damper.

The first drive unit and the second drive unit may be configured to be energised by the same signal. By utilising the same signal, complete cancellation of forces as a result of displacing the first translatable part and the second translatable part may be achieved.

The first surround may attach directly or indirectly to the first diaphragm.

The first damper (which may be referred to as a “spider”) may attach directly or indirectly to the moving assembly.

The direction of measurement may correspond to a direction in which the width of the damper body of the first damper is shortest. In some examples, the first damper may be non-circular, e.g. of racetrack shape. By arranging the shortest width of the first damper body to exceed the corresponding width of the surround body, greater displacement may be achievable and the linear response to displacement improved.

The outside tab of the first surround may be attached to the housing at a first surround landing surface on the housing. The outside tab of the first damper may be attached to the housing at a first damper landing surface on the housing.

The centre of mass of the translatable part of the first drive unit may have a position along the movement axis that is between the first surround landing surface and the first damper landing surface.

By suspending the moving assembly from the housing such that the centre of mass of the translatable part of the first drive unit is located between the first surround landing surface and the first damper landing surface, rocking of the moving assembly may be inhibited. More particularly, the rocking modes of the bass loudspeaker system may be pushed outside of the working frequency range of the bass loudspeaker system.

The mass of the translatable part of the first drive unit may correspond to the mass of voice coil windings of a voice coil or may alternatively correspond to the total mass of a permanent magnet and flux guiding elements. As described below in further detail, the translatable part of the first drive unit may include the voice coil or alternatively include the permanent magnet and the flux guiding elements.

The bass loudspeaker system may be operable to move the first moving assembly from a rest position to a maximal displacement position. Moving the first moving assembly from the rest position to the maximal displacement position may cause deflection (i.e. deformation as a result of a load) of the first damper. A maximum damper deflection angle may be defined as an angle formed between: a first line extending between an innermost location on the outside tab of the first damper and an outermost location on the inside tab of the first damper when the first moving assembly is at rest; and a second line extending between the same innermost location on the outside tab of the first damper and the same outermost location on the inside tab of the first damper when the first moving assembly is at its maximal displacement position. The innermost location on the outside tab of the first damper and the outermost location on the inside tab of the first damper may be on the same side of the movement axis. The first line and the second line may extend in a plane encompassing the movement axis. The maximum damper deflection angle may be 25 degrees or less, e.g. with a view to maintaining linear performance of the damper.

The first drive unit may include a voice coil, a permanent magnet and a plurality of flux guiding elements.

Preferably, the stationary part of the first drive unit may include the permanent magnet and the plurality of flux guiding elements, with the translatable part of the first drive unit including the voice coil. It is also possible for the stationary part of the first drive unit to include the voice coil, with the translatable part of the first drive unit including the permanent magnet and the plurality of flux guiding elements.

A total mass of the flux guiding element may be in a range of 0.8 to 1.2 times a mass of the permanent magnet.

The bass loudspeaker system according to the first aspect enables utilisation of a large drive unit, and especially a large stationary part. Thus, it may not be necessary to rely on a small high-performance magnet, such as neodymium, but instead a comparatively weak, large, yet much more cost-effective permanent magnet may be used. As a result of the comparative weakness, the permanent magnet may make up a more significant proportion of the stationary part, since smaller flux guiding elements may be needed to accommodate the flux produced by the permanent magnet.

The first drive unit may comprise a ferrite magnet. Preferably, the permanent magnet may be the ferrite magnet. The density of ferrite is approximately 5 g/cm3 (grams over cubic centimetres) smaller than that of steel, as may be commonly used for the flux guiding elements. Hence, using more ferrite and less steel may provide a surprisingly lightweight drive unit.

The permanent magnet of the first drive unit may have a mass in a range of 0.8 to 1.2 times a mass of the voice coil of the first drive unit, preferably where the permanent magnet is a ferrite magnet.

The permanent magnet of the first drive unit may have a smaller mass than the mass of the voice coil of the first drive unit, preferably where the permanent magnet is a neodymium magnet. That is to say, the permanent magnet of the first drive unit may have a first mass, the voice coil of the first drive unit may have a second mass, and the first mass may be smaller than the second mass. The first mass may be smaller than the second mass by at least a factor of two, or even by at least a factor of 2.5, for example by a factor of 2.8.

In a conventional loudspeaker, the mass of the permanent magnet is typically relatively large compared to the mass of the voice coil. However, the wider damper of the present invention allows for a comparatively heavy, and hence large/dense, voice coil. This large/dense voice coil may be combined with a smaller and/or lighter permanent magnet, e.g. a ferrite magnet as discussed above, with the additional weight in the voice coil compensating for the weaker permanent magnet. Accordingly, the combination of a smaller permanent magnet and a larger/denser voice coil may help to achieve desired performance parameters, whilst reducing weight of the loudspeaker and weight of the permanent magnet. In view of the increasing prices for rare earth magnets, this may provide for a more cost-effective configuration.

The housing may include a first housing portion, a second housing portion, and a third housing portion. The third housing portion may be between the first housing portion and the second housing portion.

The first surround may be attached to the first housing portion. The first damper may be attached to the first housing portion or the third housing portion. The stationary part of the first drive unit may be attached to the third housing portion.

The second surround may be attached to the second housing portion. The second damper may be attached to the second housing portion or the third housing portion. The stationary part of the second drive unit may be attached to the third housing portion.

By providing three housing portions, assembly of the bass loudspeaker system may be improved.

The first housing portion and the third housing portion may be joined together at a location outwards from the outside tab of the first damper.

The second housing portion and the third housing portion may be joined together at a location outwards from the outside tab of the second damper.

By joining the first/second housing portion to the third housing portion at the location outwards from the outside tab of the respective damper, assembly of the bass loudspeaker system may be improved.

The stationary part of the first drive unit may include a first U-yoke. The stationary part of the second drive unit may include a second U-yoke. Each U-yoke may include a base portion and a wall portion extending from the base portion. The base portion of the first U-yoke and the base portion of the second U-yoke may be integrally formed.

By providing a combined yoke, which may be referred to as an “H-yoke”, including the first U-yoke and the second U-yoke, assembly and performance of the bass loudspeaker system may be improved.

The translatable part of the first drive unit may include a voice coil. The first moving assembly may include a first sleeve extending along the movement axis and around the voice coil and at least a portion of the stationary part of the first drive unit. The inside tab of the first damper is attached to the sleeve of the first moving assembly.

The first inner sleeve may provide an improved structure for attaching the first damper to the first moving assembly, since first sleeve extends around the first voice coil as well a portion of the stationary part of the first drive unit. Thus, positioning of the first damper may be improved and rocking inhibited.

The first sleeve may define a first plurality of ventilation holes therethrough to enable airflow through the first sleeve in a direction generally perpendicular to the movement axis.

A voice coil former of the translatable part of the first drive unit may form a second plurality of ventilation holes therethrough to enable airflow through the voice coil former in a direction generally perpendicular to the movement axis.

By providing the first and/or second plurality of ventilation holes, internal blowing noise of air rushing through the first drive unit may be reduced.

The translatable part of the first drive unit may include a flux guiding element, e.g. a U-yoke, and may include a permanent magnet. Conversely, the stationary part of the first drive unit may include a voice coil.

The flux guiding element may serve as the first diaphragm and the inside tab of the first damper may be attached to the flux guiding element.

By providing the flux guiding element and the permanent magnet as the translatable part, construction of the loudspeaker may be improved. Such improvements may relate to running of lead wires or attachment of the first damper to the first moving assembly (e.g. by directly attaching to the flux guiding element).

The first damper may be arranged to divide an internal volume of the housing into a first volume at one side of the first damper and a second volume at the other side of the first damper. The first damper may form a plurality of ventilation holes therethrough to enable airflow through the first damper. By providing the ventilation holes through the first damper, internal blowing noise of air rushing through the first drive unit may be reduced.

A second aspect of the invention may provide an automobile comprising a bass loudspeaker system according to the first aspect. More particularly, the bass loudspeaker system may be provided at a footwell or under the seat of the automobile, or indeed in any other location suitable for packaging a bass loudspeaker system in the automobile.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 is a sectional view of a loudspeaker assembly implementing known principles.

FIG. 2 is a sectional view of an exemplary loudspeaker.

FIG. 3 is a sectional view of part of the loudspeaker of FIG. 2 in a rest configuration.

FIG. 4 is a sectional view of part of the loudspeaker of FIG. 2 in a displaced configuration.

FIG. 5 is a sectional view of another exemplary loudspeaker.

FIG. 6 is a sectional view of yet another exemplary loudspeaker.

FIG. 7 is a sectional view of yet another exemplary loudspeaker.

FIG. 8 is a sectional view of yet another exemplary loudspeaker.

FIG. 9 is a schematic view of an automobile including the loudspeaker of FIG. 2.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

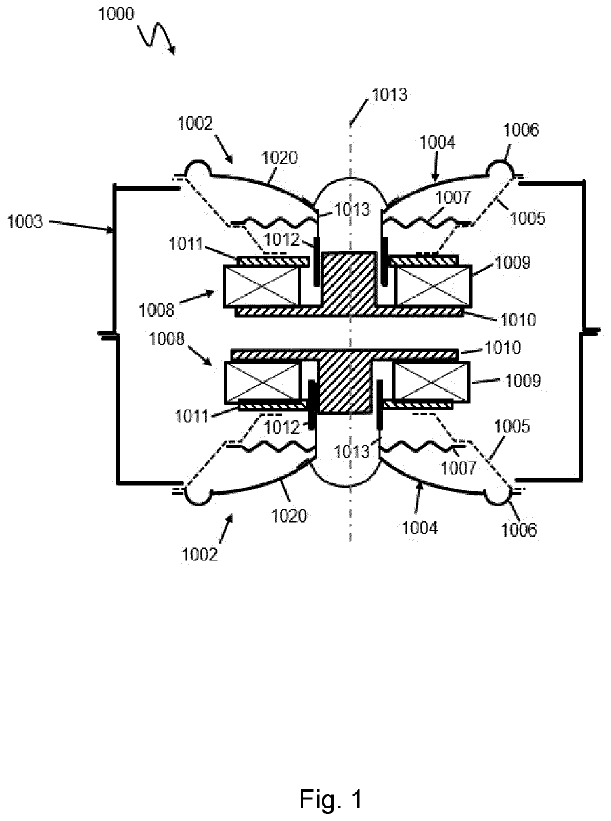

FIG. 1 is a sectional view of a loudspeaker assembly 1000 implementing known principles. The loudspeaker assembly 1000 includes a pair of bass loudspeakers 1002 mounted in a box 1003. Each bass loudspeaker 1002 includes a moving assembly 1004 suspended in a frame 1005. Each moving assembly is suspended in the respective frame 1005 by means of a surround 1006 and a damper 1007.

The frame 1005 has a generally conical shape to which the surround 1006 and the damper 1007 are attached and, conversely, which limits the size of the surround 1006 and the damper 1007. As can be seen in FIG. 1, the surround 1006 is wider than the damper 1007.

Each loudspeaker 1002 includes a drive unit 1008. The drive unit 1008 includes a ferrite ring magnet 1009, a T-yoke 1010 and a washer 1011, which in combination generate a static magnetic field for interaction with an energised voice coil 1012 on a voice coil former 1013. The voice coil former 1013 has a diameter which is the same as an inside diameter 1007 of the damper 1007. This arrangement, particularly for a heavy voice coil 1012 and/or a shallow loudspeaker, this may increase the risk of rocking and rubbing of the voice coil 1012 against static parts of the drive unit 1008.

Effective low frequency sound reproduction from a small, closed box 1003 requires a comparably large moving mass of the loudspeaker 1002. The force generated by the drive unit 1008 (or ‘motor system’) moving this mass also generates a reaction force on the frame 1005 of equal magnitude and opposite direction. This leads to vibrations of a cabinet. To cancel out these forces on the cabinet, mounting two loudspeakers 1002 on opposite sides of the box 1003 as shown in FIG. 1 may be utilised.

The bass loudspeakers 1002 may typically be manufactured independently and then mounted into the box 1003. The box 1003 may be made from a polymer, e.g. PP or PC, by means of injection moulding, and may be pre-assembled from two half-shells. Larger boxes are often made from wood or an engineered wood-product such as MDF or Multiplex. In any case, their manufacturing is completely independent of the loudspeaker 1002. Loudspeaker frames 1005 are traditionally either made from metal by means of deep drawing and stamping or from a polymer by means of injection moulding. In any case, it is preferred to not have an undercut in the design meaning that it can be effectively formed by one or several tools acting strictly axial with respect to a final main radiation axis 1019 of the loudspeaker 1002. This requirement leads to the fact that the surround outside diameter is always larger than the outside diameter of the damper 1007. Having the loudspeaker 1002 following the traditional shape of large cone, smaller damper and even smaller magnet system allows for front mounting in a pre-assembled box.

The size of a loudspeaker diaphragm 1020 relative to the box size has an influence on the in-box resonance frequency at given moving mass. The larger the diaphragm 1020, the higher the in-box resonance frequency as enclosed air acts on the diaphragm 1020 and so provides further stiffness in addition to the mechanical stiffness of the suspension elements 1006, 1007. Although this stiffness can be very high for small boxes, it is linear with regards to the cone displacement, although not strictly constant. The mechanical stiffness of a loudspeaker 1002, however, is not constant and engineering effort must be spent to keep it linear over a desired range. It may be possible to design a traditional rubber half-roll surround 1006 to be linear over a working range of the loudspeaker 1002 without significant effort. The mechanical dimensions are directly related to the maximum displacement. By contrast, a traditional damper 1007 is made from a canvas-woven cloth, dipped in a thermoset resin, and baked to final shape, and may require dedicated engineering effort to achieve the desired linearity. The number of waves, height-to-pitch ratio, cloth and weaving type, type of resin and resin density may all have a substantial influence on the stiffness vs displacement behaviour of the damper 1007. For a given inside diameter of the damper 1007, the outside diameter defines the achievable linear displacement even when all other parameters are chosen optimal. Beyond a certain displacement, the stiffness curve of the damper 1007 becomes very progressive leading to a nonlinear output vs input relationship of the loudspeaker 1002 as increased voltage cannot linearly be translated into increased displacement.

Another factor which may affect space available for the damper 1007 is the choice and placement of the magnet 1009. In the known example of FIG. 1, the magnet 1009 is positioned radially outwards of the voice coil 1012. An alternative arrangement with a magnet inside the voice coil 1012 may be less common and mainly seen with Neodymium magnets. The reason that ferrite magnets inside the voice coil 1012 are rare is that their magnetic strength is weak compared to Neodymium magnets and for a given voice coil size the magnetic field strength in the airgap may be too small for many applications. The present inventor has envisaged that a possible solution to this may be to increase the diameter of the voice coil 1012, but this necessarily increases the inside diameter of the damper 1007 and therefore may make it more difficult to achieve high linearity as the outside diameter of the damper 1007 is limited by the cone size and associated surround 1006 due to the standard manufacturing process of the frames 1005.

Hence, for low frequency reproduction from a loudspeaker with a low in-box resonance frequency from a small box 1003 it is desirable to have a comparably small diaphragm with a suspension from a surround and a damper that allows for large and linear displacement.

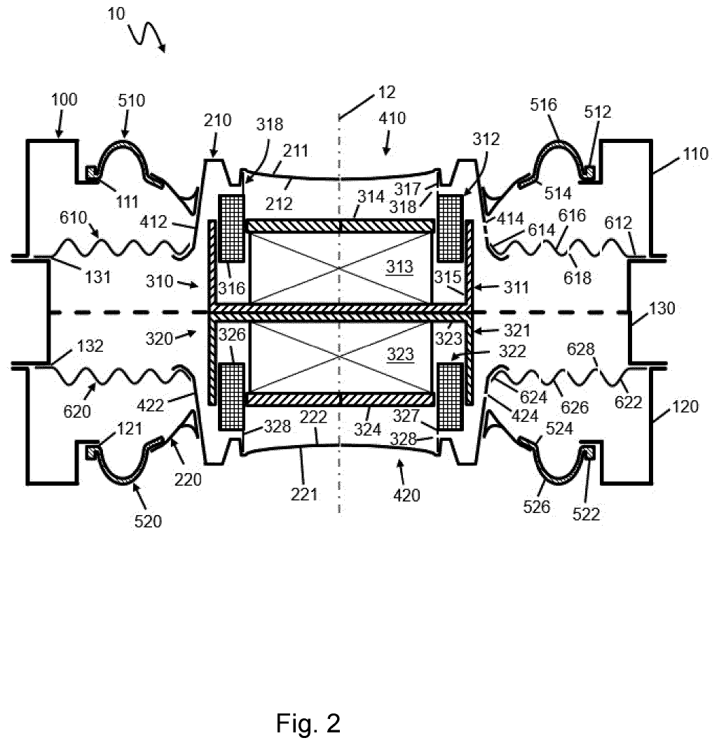

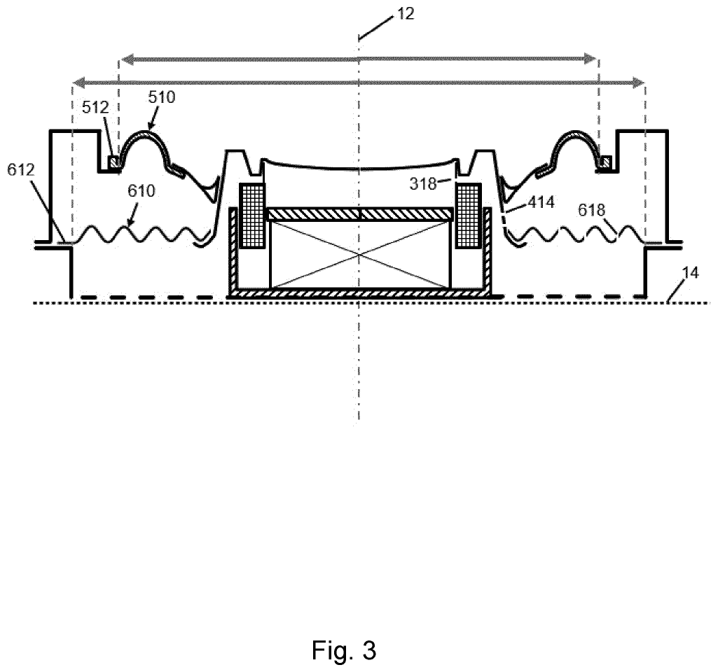

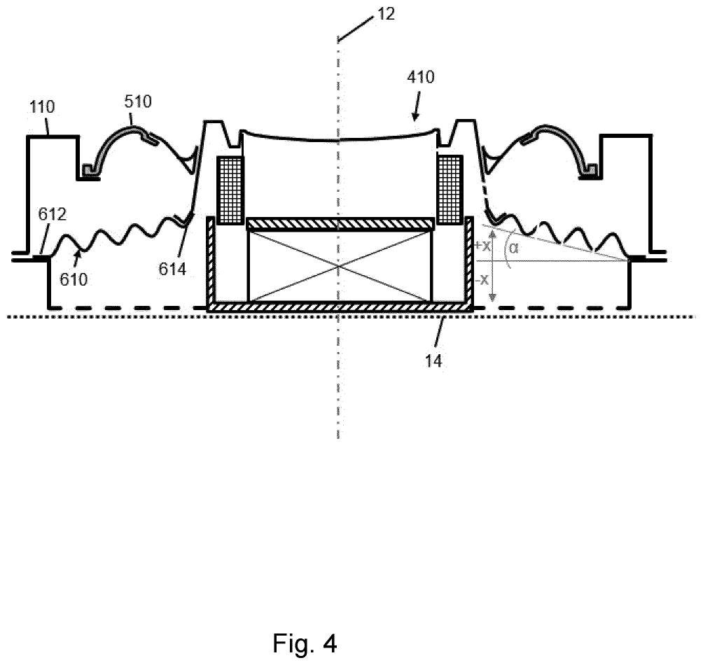

FIGS. 2, 3 and 4 illustrate an exemplary bass loudspeaker system 10. FIG. 2 is a sectional view of the bass loudspeaker system 10. FIGS. 2 and 3 are sectional views of part of the bass loudspeaker system 10, illustrating a rest position and a maximal displacement position. FIGS. 3 and 4 only show a portion of the loudspeaker system 10 shown in FIG. 2, so as to help more clearly see the components thereof.

The bass loudspeaker system 10 includes a housing 100, a first diaphragm 210 and a second diaphragm 220, a first drive unit 310 and a second drive unit 320. Each drive unit 310, 320 includes a stationary part 311, 321 attached to the housing 100 and a translatable part 312, 322.

The stationary part 311, 321 of each drive unit 310, 320 includes a permanent magnet 313, 323 and a plurality of flux guiding elements 314, 315, 324, 325. The plurality of flux guiding elements includes a washer 314, 324 and a yoke 315, 325, provided as a U-yoke. The permanent magnet 313, 323 generates a static magnetic field between the washer 314, 324 and the U-yoke 315, 325, which penetrates the translatable part 312, 322 of the drive unit 310, 320.

A total mass of the plurality of flux guiding elements 314, 315 of the first drive unit 310 may be in a range of 0.8 to 1.2 times a mass of the permanent magnet 313 of the first drive unit 310. Similarly, a total mass of the plurality of flux guiding elements 324, 325 of the second drive unit 310 may be in a range of 0.8 to 1.2 times a mass of the permanent magnet 323 of the second drive unit 320.

The translatable part 312 of the first drive unit 310 is attached to the first diaphragm 210 to form a first moving assembly 410. The translatable part 322 of the second drive unit 320 is attached to the second diaphragm 220 to form a second moving assembly 420. The loudspeaker system 10 is operable to energise the first drive unit 310 and the second drive unit 320 to cause the first moving assembly 410 and the second moving assembly 420 to move along a movement axis 12 in opposite directions to produce sound. More particularly, each diaphragm 210, 220 has a first sound radiating surface 211, 221 and a second sound radiating surface 212, 222. The first sound radiating surface 211, 221 faces away from the housing 100 and is in use utilised for producing sound.

The first moving assembly 410 is suspended from the housing 100 by a first surround 510 and a first damper 610. The first surround 510 includes an outside tab 512 attached to the housing 100, an inside tab 514 attached to the first diaphragm 210, and a surround body 516 between the outside tab 512 and the inside tab 514. The first damper 610 includes an outside tab 612 attached to the housing 100, an inside tab 614 attached to the first moving assembly 410 and a damper body 616 between the outside tab 612 and the inside tab 614.

Likewise, the second moving assembly 420 is suspended from the housing 100 by a second surround 520 and a second damper 620. The second surround 520 includes an outside tab 522 attached to the housing 100, an inside tab 524 attached to the second diaphragm 210, and a surround body 526 between the outside tab 522 and the inside tab 524. The second damper 620 includes an outside tab 622 attached to the housing 100, an inside tab 624 attached to the second moving assembly 420 and a damper body 626 between the outside tab 622 and the inside tab 624.

The width of the damper body 616 of the first damper 610 as measured in a direction of measurement perpendicular to the movement axis 12 is greater than the width of the surround body 516 of the first surround 510 in said direction of measurement. Correspondingly, the width of the damper body 626 of the second damper 620 as measured in said direction of measurement is greater than the width of the surround body 526 of the second surround 520 in said direction of measurement. In FIG. 3, the width of the first surround body 516 (upper double-headed arrow) and the width of the first damper body 616 (lower double-headed arrow) are illustrated.

The housing 100 includes a first housing portion 110, a second housing portion 120 and a third housing portion 130. The third housing portion 130 is located between the first housing portion 110 and the second housing portion 120. In use, the first diaphragm 210 radiates sound from the first housing portion 110 while the second diaphragm 220 radiates sound from the second housing portion 120.

The first surround 510 is attached to the first housing portion 110. The second surround 520 is attached to the second housing portion 120. More particularly, the outside tab 512 of the first surround 510 is attached to the first housing portion 110 at a first surround landing surface 111 on the housing 100, and the outside tab 522 of the second surround 520 is attached to the second housing portion 120 at a second surround landing surface 121.

The outside tab 612 of the first damper 610 is attached to the third housing portion 130 at a first damper landing surface 131 on the third housing portion 130. The outside tab 622 of the second damper 620 is attached to the third housing portion 130 at a second damper landing surface 132 on the third housing portion 130.

The centre of mass of the translatable part 312 of the first drive unit 310 has a position along the movement axis 12 that is between the first surround landing surface 111 and the first damper landing surface 131. That is to say, the first surround landing surface 111 and the first damper landing surface 131 are spaced apart along the movement axis 12 and the centre of mass of the translatable part 312 is located therebetween. Similarly, the centre of mass of the translatable part 322 of the second drive unit 320 has a position along the movement axis 12 that is between the second surround landing surface 121 and the second damper landing surface 132.

The first housing portion 110 and the second housing portion 120 are each joined to the third housing portion 130. The first housing portion 110 and the third housing portion 130 are joined together at a location outwards from the outside tab 612 of the first damper 610. Likewise, the second housing portion 120 and the third housing portion 130 are joined together at a location outwards from the outside tab 622 of the second damper 620.

Each moving assembly 410, 420 includes a sleeve 412, 422, i.e. a first sleeve 412 and a second sleeve 422. The sleeve 412, 422 provides structure for attachment of the moving assembly 412, 420 to the damper 610, 620. Suitably, the sleeve 412, 422 extends along the movement axis 12, and extends around the translatable part 312, 322 and at least part of the stationary part 311, 321 of the drive unit 310, 320. The inside tab 614 of the first damper 610 is attached to the first sleeve 412 while the inside tab 624 of the second damper 620 is attached to the second sleeve 422. In this example, the translatable part 312, 322 includes a voice coil 316, 326 carried on a voice coil former 317, 327. Thus, the voice coil 316, 326 is connected to the sleeve 412, 422 which further connects to the diaphragm 210, 220 and the damper 610, 620. The diaphragm 210, 220 connects the sleeve 412, 422 with the surround 510, 610 acting as first suspension element relative to the housing 100. The damper 610, 620 connects the sleeve 412, 422 with the housing 100 and acts as second suspension element. An arrangement using the sleeve 412, 422 and the damper inside diameter radially outwards of the U-yoke allows for a shallow loudspeaker design and excellent rocking stability as the centre of mass of the translatable part 312, 322 is between the two respective landing surface 111, 121, 131, 132.

The first sleeve 412 defines a first plurality of ventilation holes 414 to enable airflow through the first sleeve 412 in a direction generally perpendicular to the movement axis 12. Likewise, the second sleeve 422 is provided with a second plurality of ventilation holes 424 to enable airflow through the second sleeve 422.

Each voice coil former 317, 327 forms a plurality of ventilation holes 318, 328 to enable airflow through the voice coil former 317, 327 in a direction generally perpendicular to the movement axis 12.

A plurality of ventilation holes 618, 628 is formed by the damper bodies of the first damper 610 and the second damper 620. The ventilation holes 618, 628 are provided to enable airflow through the damper 610, 620. The ventilation holes 618, 628 may be provided by a particularly open damper weaving.

The ventilation holes in the voice coil former 317, 327, the lower part of the sleeve 412, 422 and the damper 618, 628 may increase the airflow between the volumes underneath the dustcap, between the diaphragm 210, 220 and the damper 610, 620 and between the damper 610, 620 and symmetry plane 14. Such arrangements may reduce internal blowing noise resulting from air rushing through the airgap and the damper 618, 628 during operation.

In FIGS. 3 and 4, a rest position and a maximal displacement position of the first moving assembly 410 are illustrated. More particularly, FIG. 3 shows the first moving assembly 410 at the rest position while FIG. 4 shows the first moving assembly 410 at the maximal displacement position.

The bass loudspeaker system 10 is operable to move the first moving assembly 410 from the rest position to the maximal displacement position, thereby causing deflection (or ‘deformation’) of the first damper 610. A maximum damper deflection angle α (alpha) is defined as the angle formed between a first line and a second line. The first line extends between the outside tab 612 of the first damper 610, e.g. an innermost location of the outside tab 612, and the inside tab 614 of the first damper 610, e.g. an outermost location on the inside tab 614, when the first moving assembly 410 is at rest. The second line extends between the same locations of the outside tab 612 and the inside tab 614 of the first damper 620 when the first moving assembly 410 is at its maximal displacement position. These locations are on the same side of the movement axis 12, i.e. the first line and the second line do not extend across to the other side of the loudspeaker system 10. The first line and the second line extend in a plane encompassing the movement axis 12.

The maximum damper deflection angle α is preferably no more than 25 degrees.

The two moving assemblies 410, 420 of the loudspeaker system 10 are mounted in the housing 100 in back-to-back configuration in a symmetric arrangement around a symmetry plane 14 normal to the movement axis 12 (or ‘main radiation axis’). The moving assemblies 410, 420 radiate sound with equal magnitude but in opposite direction when energised. The acoustic volume inside the housing 100 can be common, i.e. shared by the two moving assemblies 410, 420 or split at the symmetry plane 14.

The loudspeaker system 10 allows for large dampers 610, 620 with improved linearity while still working with low-cost traditional materials. The outside diameter of the damper 610, 620 is increased to attach to the housing 100, thereby exceeding the size of the surround 510, 520. Thus, the inside diameter can be enlarged without adversely affecting damper linearity for intended displacement, even when also increasing the damper inside diameter. In this example, the comparatively large damper outside diameter allows the damper 610, 620 to have a linearity exceeding the 10 mm (millimetres) of displacement by the drive unit 310, 320 and so provides clean and powerful bass reproduction.

The space enclosed by the damper inside diameter is used for a large voice coil and a large magnet inside of the voice coil. The use of a large inside ferrite magnet allows for a low-cost solution with usable drive unit strength suitable for the intended applications. Also, U-yoke magnet systems with the magnet inside the voice coil are inherently more efficient as compared to T-yoke magnet systems, because there is comparatively little leakage flux on the outside diameter of the magnet. Moreover, it is possible to increase the number of windings and layers of windings on the voice coil and utilising a comparatively wide airgap and increased reluctance of the magnetic circuit. The relatively small total flux in the magnetic circuit allows for a thin washer and a U-yoke with thin wall thickness keeping the total mass of the motor system low. The density of ferrite is with approximately 5 g/cm3 smaller than that of steel so using a motor system with more ferrite and less steel in the flux guiding elements can be surprisingly lightweight.

In this example, the ferrite magnet has a maximum energy product of BHmax=30 KJ/m3 (Kilojoules/cubic metres) and a remanent flux density of Br=0.4 T (Tesla). The diameter is 50 mm (millimetres) and the height is 20 mm. The voice coil is wound from 0.43 mm copper wire and has a winding height of 17 mm in 8 layers. This results in a force factor of 7.5 Tm (Tesla*metres) at rest position and a motor linearity of +−10 mm within 50% (percent) of the force factor at rest position.

The manufacturing process may be very similar to that of conventional loudspeaker. In this example, the loudspeaker system 10 is integrally built with the housing 100 as it is built up. The magnet system of flux guides 314, 315, 324, 325 and permanent magnet 313, 323, the voice coil 316, 326, the sleeve 412, 422 and the damper 610, 620 are first mounted into the third housing portion 130, which provides an axially central portion. Then, the portion 110, 120 of the housing 100 farther from the symmetry plane 14 is placed and joined to the third portion 130 by means of an adhesive. This split of the housing 100 may improve assembly where the outside diameter of the surround is smaller than the inside diameter of the damper. Or expressed differently, where the damper extends further than the surround. This allows the use of a large and linear damper at low axial stiffness while providing good radial centring effectively preventing rocking or rubbing of the voice coil against the stationary parts. This arrangement may be particularly useful for loudspeakers with a large, low-cost magnet and consequently large voice coil where the radial distance between bottom end of the inner cone and outside diameter of the surround becomes very small.

As can be appreciated from the above explanation, the manufacturing process of the loudspeaker system 10 may not be more difficult than that of a traditional loudspeaker. In fact, having the outer portions 110, 120 of the housing 100 not present during placement of the damper 610, 620 and guiding and shaping of the leadwires, connecting the voice coil 316, 326 to the terminals, may be preferred. If the magnet system 314, 315, 324, 325 is built in last and the assembly of the translatable part 410, 420 is carried out on a jig, a dustcap portion can be integrated with the sleeve 412, 422 and hence reducing the number of components as compared to a traditional loudspeaker build. In FIGS. 2, the dustcap portion of the sleeve 412, 422 has a dome shape and can be made rather thin and stiff. The diaphragm 210, 220 has a large inner diameter and can be made stiff, e.g., by a steep cone angle. All structural connections are on a comparably large diameter, the stresses on the structural connections are small. In this example, structural connection is made with glue, such that the acting forces are distributed over long, circumferential glue beads.

It may conventionally be believed that in small boxes the stiffness of the box is dominant over the mechanical stiffness. While this may be true around rest position, dampers with a small radial distance between inner diameter and outer diameter are typically non-linear for larger displacements resulting in compressed music reproduction. The mechanical stiffness may be 4 N/mm (Newtons/millimetres) and so little compared to the stiffness of the box: The effective cone area of 112 cm2 (square centimetres) in 2 litres adds additional 10 N/mm. However, this 10 N/mm is very linear with displacement and creates hardly any audible distortion. A mechanical suspension, however, using too small a damper will quickly rise from 4 N/mm to 16 N/mm and beyond for displacements larger than 4 to 5 mm. This steep rise hampers the faithful music reproduction and leads to undesired distortion.

The damper 610, 620 in the shown arrangement is made from traditional materials such as woven cloth impregnated with thermoset resin and baked to shape, but any suitable material may be used. Its design and function are well known to the skilled in the field. For example, the larger size allows the use of lower cost materials such as Polycotton instead of Kevlar™ and may wear out much slower and lesser degree than a small damper being heavily stressed by large displacements in operation.

The permanent magnet 313, 323 is provided as a ferrite magnet. Since the damper 610, 620 is capable of accommodating a large magnet without adversely affecting desired linearity of the damper 610, 620, the use of a large inside ferrite magnet allows for a low-cost solution with usable drive unit strength suitable for the intended application.

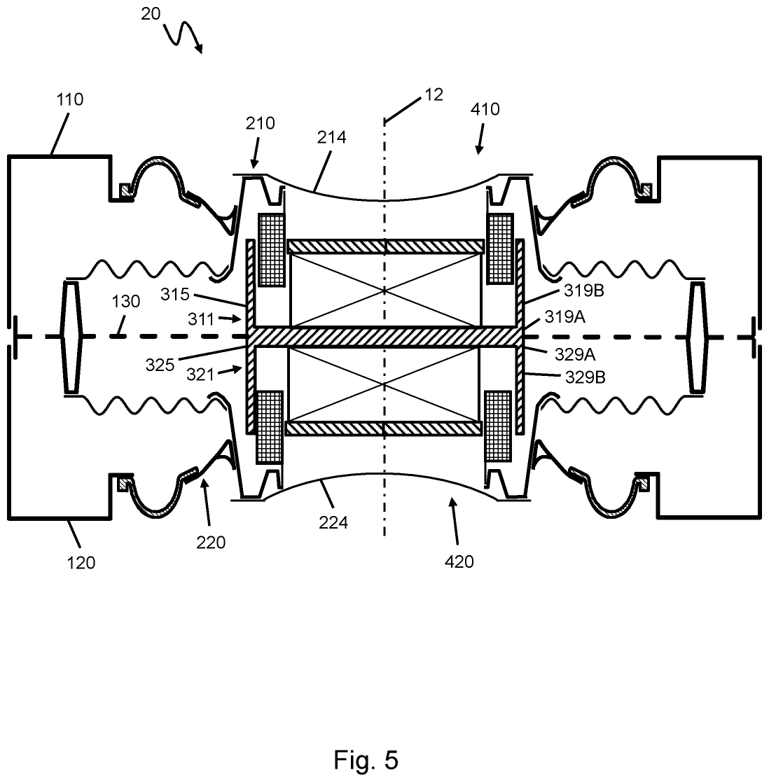

FIG. 5 is a sectional view of another exemplary bass loudspeaker system 20. The loudspeaker system 20 is similar to the loudspeaker system 10 of FIGS. 2, 3, 4. The same reference numbers are used for corresponding features and detailed description of such features is omitted.

According to the example of the loudspeaker system 20, the first housing portion 110 and the second housing portion 120 meet when assembled. Hence, a single split line is visible, rather than multiple split lines, despite the housing 100 including more than just two shells joined together. Alternatively, other known techniques for avoiding visible split lines may be used, such as hot-plate welding, ultrasonic welding and the like, which are well-known in the industry and widely available techniques.

When assembling the loudspeaker system 20, insertion of the magnet system may be the final step before joining of the housing portions 110, 120 to the complete assembly of the loudspeaker system 20.

Each diaphragm 210, 220 includes a separate dustcap 214, 224. The dustcap 214, 224 in use covers the drive unit 310, 320 which would otherwise be exposed.

The U-yoke 315, 325 of the stationary part 311, 321 of each drive unit 310, 320 includes a base portion 319A and a wall portion 319B extending from the base portion. In this example, the first U-yoke 315 and the second U-yoke 325 are provided in back-to-back configuration. More particularly, the base portion of the first U-yoke 315 and the base portion of the second U-yoke 315 are integrally formed and the wall portion of the first U-yoke 315 and the wall portion of the second U-yoke 325 extend into opposite directions from the joined base portion. A single outer flux guiding element from two U-yokes 315, 325 in back-to-back configuration, as in this example, may be referred to as an H-yoke.

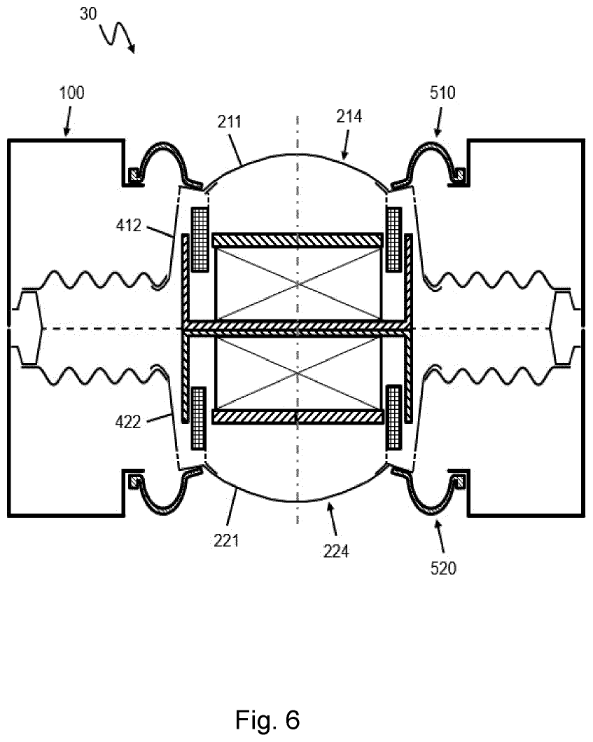

FIG. 6 is a sectional view of another exemplary bass loudspeaker system 30. The loudspeaker system 30 is similar to the loudspeaker system 10 of FIGS. 2, 3, 4. The same reference numbers are used for corresponding features and detailed description of such features is omitted.

As shown in FIG. 6, the diaphragms 110, 120 are provided by the dustcaps 214, 224. That is to say, the sound radiating surfaces 211, 221 are exclusively formed by the dustcaps 214, 224.

In this example, the dustcaps 214, 224 are formed integrally with the sleeves 412, 422 to define a single structure which directly connects to the voice coil former 317, 327, the surround 510, 520 and the damper 610, 620. Especially in this case, it may be beneficial to add radial ventilation holes, as described above, connecting the air volumes underneath the dustcap 214, 224 with the air volume above and below the damper 610, 620.

The present example may very clearly illustrate a benefit of the loudspeaker system 30 according to the invention. In the configuration shown in FIG. 6, there is no space for a traditional frame which would be mounted in the housing 100 (serving as the traditional box) and that would be able to accommodate a useful damper of traditional shape. In particular, in the configuration of FIG. 6 the inner landing surface of the surround 510, 520 is located at the voice coil former 317, 327. Such a configuration may not be possible with a conical frame of traditional design.

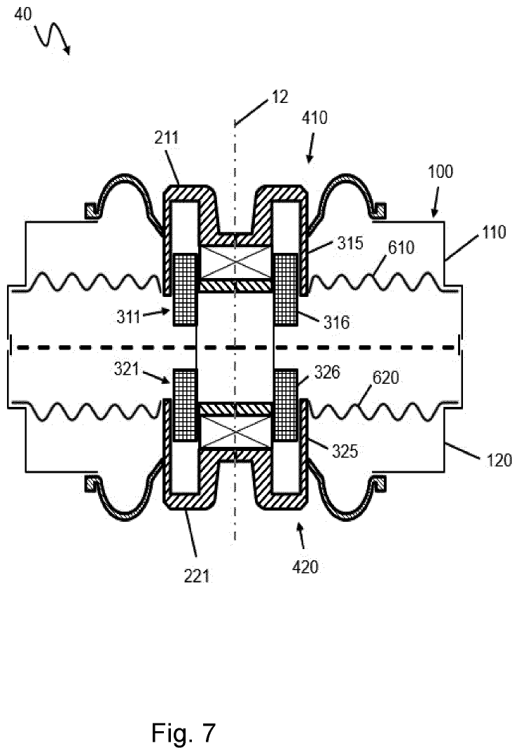

FIG. 7 is a sectional view of another exemplary bass loudspeaker system 40. The loudspeaker system 40 is similar to the loudspeaker system 10 of FIGS. 2, 3, 4. The same reference numbers are used for corresponding features and detailed description of such features is omitted.

In FIG. 7, a loudspeaker system is shown which may be considered radically different, in which the voice coils 316, 326 are fixed to the housing 100 and the magnet systems are moveable. It can be used with cones or, as shown, the surrounds 510, 520 directly connected to the U-yoke 315, 325. Again, the large outside diameter of the damper 610, 620 allows this arrangement to be useful and allows for high, linear displacement of a small effective cone area in a small box with very low resonance frequency.

As shown in FIG. 7, the diaphragm 110, 120 corresponds to the flux guide 315, 325. That is to say, the sound radiating surfaces 211, 221 are exclusively formed by the flux guides 315, 325.

In this example, the first surround 510 and the first damper 610 are both attached to the first housing portion 110, while the second surround 520 and the second damper 620 are both attached to the second housing portion 120.

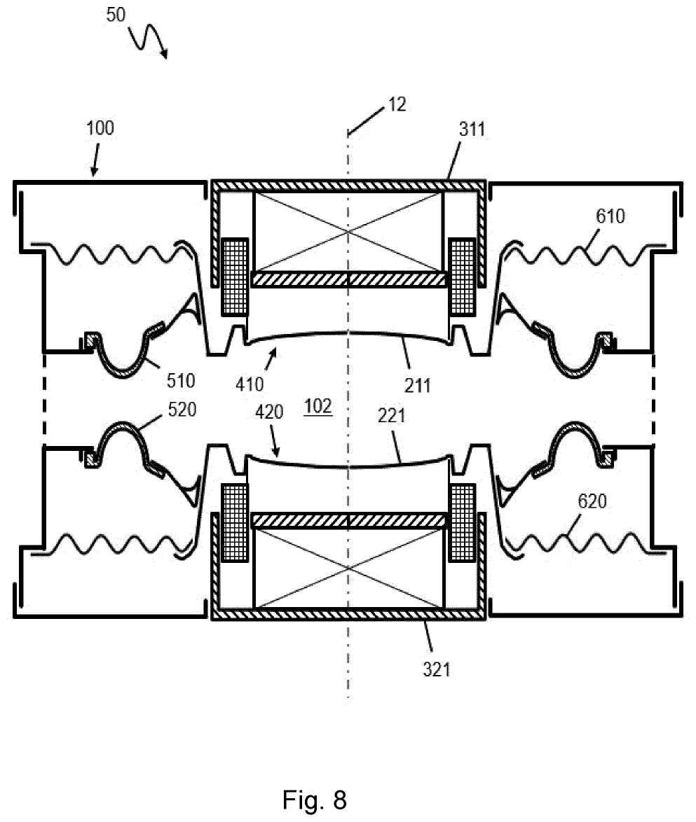

FIG. 8 is a sectional view of another exemplary bass loudspeaker system 50. The loudspeaker system 50 is similar to the loudspeaker system 10 of FIGS. 2, 3, 4. The same reference numbers are used for corresponding features and detailed description of such features is omitted.

In FIG. 8, yet another arrangement according to the invention is shown. As in previous arrangements, the radiation axis 12 is common and the moving assemblies 410, 420 radiate sound of same magnitude in opposite direction. The design is still force cancelled, but the interaction via the magnet systems is not as immediate as when they are joined together. Suitably, the housing is configured to be stiffer than previous arrangements. The moving assemblies radiate into a common cavity 102 which is then ventilated towards the outside world. Again, the outside diameter of the dampers 610, 620 is larger than the outside diameter of the surround 510, 520.

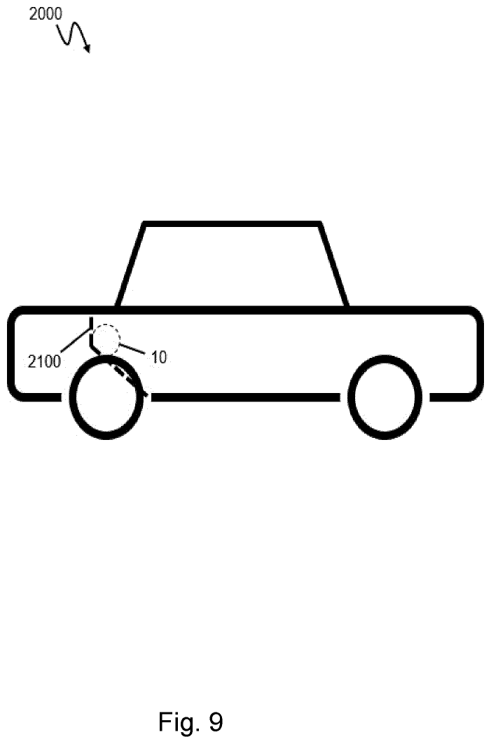

FIG. 9 is a schematic view of an automobile 2000 including the bass loudspeaker system 10. Any exemplary loudspeaker system as described above may be installed in the automobile 2000. In this example, the loudspeaker system 10 described above is provided between the footwells 2100 of the automobile 2000. Other locations are also envisaged, such as at or towards the bottom of an A-style.

The bass loudspeaker systems described above have moving assemblies with circular symmetry. Other shapes for at least some of the components are also envisaged in other examples. For example, the diaphragm and the surround may have a racetrack or oval shape, while the translatable part of the drive unit and the damper may be circularly symmetric. As in the arrangements described above, the size of the damper body 616, 626 exceeds the size of the surround body 516, 526 but may do so in some direction or directions but not all directions. Preferably the size of the damper body 616, 626 exceeds the size of the surround body 516, 526 in the direction in which the surround body 616, 626 is narrower.

Different arrangements have been described above, e.g. with and without diaphragm, with and without separate dustcap. Also, the magnet material of the permanent magnet may be chosen freely, since the invention allows for the use of even relatively large ferrite tablets (but is not limited thereto).

The loudspeaker systems 10, 20, 30, 40, 50 may have in common some/all of the following aspects:
A loudspeaker system for music reproduction from an even number of moving assemblies (the system could be stacked roughly following the concepts described in either FIG. 2 or FIG. 6).
All moving assemblies sharing a common main radiation axis and as such fundamental axis of symmetry.
All moving assemblies being substantially identical with pairwise symmetry around a symmetry plane perpendicular to the main radiation axis.
All moving assemblies being energized with substantially the same signal of bass frequencies (e.g. in a working range from 20 Hz to 200 Hz).
The loudspeaker system being arranged such the mechanical forces cancel and the fixed portions of the system are effectively vibration free.
Each loudspeaker system may comprise a housing which is integral with the loudspeaker frame and a plurality of each of the following components:
   a magnet system of at least one permanent magnet and at least two flux guiding elements;
   a voice coil;
   a surround
   a damper of which the fixed diameter is larger than the fixed diameter of the surround.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

The claims are amended as follows:

1. A bass loudspeaker system including:
a housing;
a first diaphragm and a second diaphragm;
a first drive unit and a second drive unit, each drive unit including a stationary part attached to the housing and a translatable part;
wherein the translatable part of the first drive unit is attached to the first diaphragm to form a first moving assembly suspended from the housing by a first surround and a first damper, and the translatable part of the second drive unit is attached to the second diaphragm to form a second moving assembly suspended from the housing by a second surround and a second damper;
wherein the loudspeaker is operable to energise the first drive unit and the second drive unit to cause the first moving assembly and the second moving assembly to move along a movement axis in opposite directions to produce sound;
wherein the first surround includes an outside tab attached to the housing, an inside tab attached to the first diaphragm, and a surround body between the outside tab and the inside tab;
wherein the second surround includes an outside tab attached to the housing, an inside tab attached to the second diaphragm, and a surround body between the outside tab and the inside tab;
wherein the first damper includes an outside tab attached to the housing, an inside tab attached to the first moving assembly and a damper body between the outside tab and the inside tab;
wherein the second damper includes an outside tab attached to the housing, an inside tab attached to the second moving assembly and a damper body between the outside tab and the inside tab;
wherein the width of the damper body of the first damper as measured in a direction of measurement perpendicular to the movement axis is greater than the width of the surround body of the first surround in said direction of measurement; and
wherein the width of the damper body of the second damper as measured in said direction of measurement is greater than the width of the surround body of the second surround in said direction of measurement.

2. The bass loudspeaker system according to claim 1, wherein the direction of measurement corresponds to a direction in which the width of the damper body of the first damper is shortest.

3. The bass loudspeaker system according to claim 1 or 2, wherein
the outside tab of the first surround is attached to the housing at a first surround landing surface on the housing, and the outside tab of the first damper is attached to the housing at a first damper landing surface on the housing; and
wherein the centre of mass of the translatable part of the first drive unit has a position along the movement axis that is between the first surround landing surface and the first damper landing surface.

4. The bass loudspeaker system according to claim 1,
wherein the bass loudspeaker system is operable to move the first moving assembly from a rest position to a maximal displacement position, to thereby cause deflection of the first damper;
wherein a maximum damper deflection angle is defined as being an angle formed between:
a first line extending between an innermost location on the outside tab of the first damper and an outermost location on the inside tab of the first damper when the first moving assembly is at rest; and
a second line extending between the same innermost location on the outside tab of the first damper and the same outermost location on the inside tab of the first damper when the first moving assembly is at its maximal displacement position;
wherein the innermost location on the outside tab of the first damper and the outermost location on the inside tab of the first damper are on the same side of the movement axis; and
the first line and the second line extend in a plane encompassing the movement axis;
wherein the maximum damper deflection angle is no more than 25 degrees.

5. The bass loudspeaker system according to claim 1,
wherein the first drive unit includes a permanent magnet and a plurality of flux guiding elements;
wherein a mass of the flux guiding elements is in the range of 0.8 to 1.2 times the mass of the permanent magnet.

6. The bass loudspeaker system according to claim 1, wherein
the housing includes a first housing portion, a second housing portion, and a third housing portion between the first housing portion and the second housing portion;
the first surround is attached to the first housing portion;
the first damper is attached to the first housing portion or the third housing portion; and
the stationary part of the first drive unit is attached to the third housing portion.

7. The bass loudspeaker system according to claim 6,
wherein the first housing portion and the third housing portion are joined together at a location outwards from the outside tab of the first damper.

8. The bass loudspeaker system according to claim 1,
wherein the first drive unit includes a first U-yoke and the second drive unit includes a second U-yoke, each U-yoke comprising a base portion and a wall portion extending from the base portion;
wherein the base portion of the first U-yoke and the base portion of the second U-yoke are integrally formed.

9. The bass loudspeaker system according to claim 1, wherein
the translatable part of the first drive unit includes a voice coil;
the first moving assembly includes a first sleeve extending along the movement axis and around the voice coil and at least a portion of the stationary part of the first drive unit;
wherein the inside tab of the first damper is attached to the sleeve of the first moving assembly.

10. The bass loudspeaker system according to claim 9,
wherein the first sleeve defines a first plurality of ventilation holes therethrough to enable airflow through the first sleeve in a direction generally perpendicular to the movement axis; and
wherein a voice coil former of the translatable part of the first drive unit forms a second plurality of ventilation holes therethrough to enable airflow through the voice coil former in a direction generally perpendicular to the movement axis.

11. The bass loudspeaker system according to claim 1, wherein
the translatable part of the first drive unit includes a permanent magnet and a flux guiding element.

12. The loudspeaker according to claim 11, wherein the flux guiding element serves as the first diaphragm and the inside tab of the first damper is attached to the flux guiding element.

13. The bass loudspeaker system according to claim 1,
wherein the first damper is arranged to divide an internal volume of the housing into a first volume at one side of the first damper and a second volume at the other side of the first damper;
wherein the first damper forms a plurality of ventilation holes therethrough to enable airflow through the first damper.

14. The bass loudspeaker system according to claim 1,
wherein the first drive unit comprises a ferrite magnet.

15. The bass loudspeaker system according to claim 1, wherein the first drive unit includes a voice coil, a permanent magnet and a plurality of flux guiding elements, and the permanent magnet of the first drive unit has a smaller mass than the mass of the voice coil of the first drive unit.

16. An automobile including a bass loudspeaker system the bass loudspeaker system including:
a housing;
a first diaphragm and a second diaphragm;
a first drive unit and a second drive unit, each drive unit including a stationary part attached to the housing and a translatable part;
wherein the translatable part of the first drive unit is attached to the first diaphragm to form a first moving assembly suspended from the housing by a first surround and a first damper, and the translatable part of the second drive unit is attached to the second diaphragm to form a second moving assembly suspended from the housing by a second surround and a second damper;
wherein the loudspeaker is operable to energise the first drive unit and the second drive unit to cause the first moving assembly and the second moving assembly to move along a movement axis in opposite directions to produce sound;
wherein the first surround includes an outside tab attached to the housing, an inside tab attached to the first diaphragm, and a surround body between the outside tab and the inside tab;
wherein the second surround includes an outside tab attached to the housing, an inside tab attached to the second diaphragm, and a surround body between the outside tab and the inside tab;
wherein the first damper includes an outside tab attached to the housing, an inside tab attached to the first moving assembly and a damper body between the outside tab and the inside tab;
wherein the second damper includes an outside tab attached to the housing, an inside tab attached to the second moving assembly and a damper body between the outside tab and the inside tab;
wherein the width of the damper body of the first damper as measured in a direction of measurement perpendicular to the movement axis is greater than the width of the surround body of the first surround in said direction of measurement; and
wherein the width of the damper body of the second damper as measured in said direction of measurement is greater than the width of the surround body of the second surround in said direction of measurement.
